(19) United States
(12) Patent Application Publication
(10) Pub. No.: US 2026/0175062 A1
(43) Pub. Date: Jun. 25, 2026

(54) SYSTEM AND METHOD OF AUTOMATION AND/OR MONITORING OPERATION OF AN INERTING SYSTEM FOR A WET-PIPE FIRE SPRINKLER SYSTEM

(71) Applicant: Engineered Corrosion Solutions, LLC, St. Louis, MO (US)

(72) Inventors: Austin Andrews, St. Louis, MO (US); Adam H. Hilton, Chesterfield, MO (US); Mateusz Przezdziecki, St. Louis, MO (US); Aaron Troll, St. Charles, MO (US); Zachary Hume, O’Fallon, MO (US)

(21) Appl. No.: 19/391,253

(22) Filed: Nov. 17, 2025

Related U.S. Application Data
(60) Provisional application No. 63/720,831, filed on Nov. 15, 2024.

(51) Int. Cl. A62C 35/68; A62C 37/11; A62C 37/50

(52) U.S. Cl. CPC A62C 35/68; A62C 37/11; A62C 37/50

(57) ABSTRACT

A control system for operating and/or monitoring an inerting system for a wet-pipe fire sprinkler system includes a logic determining device; a user interface to display a status of the sprinkler system; at least one sensor to monitor operating parameters of the sprinkler system and transmit a signal to the logic determining device with sensor data relating to the at least operating parameter; a memory module to record the sensor data; a communications module to transmit the sensor data to a receiving device; and a power module to deliver power for the control system. Associated methods of automating and/or monitoring of an inerting system for a wet-pipe fire sprinkler system are also disclosed.

### CROSS REFERENCES

This application claims priority to U.S. Provisional Application No. 63/720,831, filed Nov. 17, 2024, the entire disclosure of which is hereby incorporated by reference herein.

### TECHNICAL FIELD

The present disclosure is directed to controls for fire sprinkler inerting systems and, more particularly, to automation and/or monitoring of a nitrogen inerting system and process for a wet-pipe fire sprinkler system.

### BACKGROUND

This section provides background information related to the present disclosure which is not necessarily prior art. The present disclosure is directed to automation and monitoring of a wet pipe nitrogen inerting (WPNI) system and method for a fire sprinkler system.

Wet pipe fire protection systems must be occasionally drained for maintenance, system upgrade, and the like, which subsequently requires reinerting the system. The reinerting process typically requires the following steps:
Drain the piping network of the fire sprinkler system of water;
Actuate the valve allowing nitrogen to flow into the piping network;
Actuate the valve again to stop the flow of nitrogen into the piping network when the system reaches a predetermined pressure;
Open a vent, a drain valve, or a combination thereof to allow the nitrogen/air mixture to escape the piping network;
Connect an oxygen analyzer to the system to obtain a sample of the percentage oxygen content within the piping network; and
Repeat the above steps as necessary to reach the desired/nitrogen/oxygen ratio.
   These steps are all currently performed manually by an operator.

According to many fire protection codes, it is necessary to place the system back into operation daily, even if the maintenance or upgrade takes multiple days. Also, it is usually necessary to be able to place the system back into operation within a relatively short defined period that is usually measured in terms of a few minutes. This draining and refilling contributes to the formation and buildup of corrosion in the piping of the wet pipe fire sprinkler system. This is caused, at least in part, from the high oxygen content air that is introduced into the system upon refilling the system. Such corrosion can lead to system failure resulting in expensive repairs. Inerting systems for fire sprinkler systems add an inert gas such as nitrogen to the piping network of the fire sprinkler system in combination with a venting process to displace oxygen from the piping network.

The inerting process involves status verification and actuation of vents and valves in the system, which occurs manually in current systems. This is a time-and labor-intensive operation that requires constant attention from personnel, and may require specialized equipment to reach components. Additionally, once completed in order for the status to be checked or monitored an operator is required to manually pull another sample. In addition, an operator must continue to collect samples of the air within the piping network during the process for status verification, which, again, is performed manually. If a building contains multiple systems these all must checked individually.

Further, there is no ready means for confirmation of proper system maintenance and traceability of operator actions for building management and owners to maintain required records with current systems other than relying on operator notes and checklists. Current systems also do not provide for monitoring of the system between maintenance operations or manual inspections.

### SUMMARY

The needs set forth herein as well as further and other needs and advantages are addressed by the present embodiments, which illustrate solutions and advantages described below.

An aspect of the present disclosure is to provide a control system for operating and/or monitoring an inerting system for a wet-pipe fire sprinkler system that includes a logic determining device; a user interface in communication with the logic determining device and configured to display a status of the wet-pipe fire sprinkler system; at least one sensor configured to monitor at least one operating parameter of the wet-pipe fire sprinkler system and wherein the at least one sensor is in communication with the logic determining device and configured to transmit a signal to the logic determining device with sensor data relating to the at least operating parameter; a memory module in communication with the logic determining device and configured to record the sensor data; a communications module in communication with the logic determining device and configured to transmit the sensor data to a receiving device; and a power module configured to deliver power for the control system.

According to another aspect of the present disclosure, at least the logic determining device, the user interface, the memory module, and the communications module are contained within a common enclosure.

According to another aspect of the present disclosure, the power module may include at least one battery.

According to another aspect of the present disclosure, the logic determining device is further configured to analyze the sensor data and determine a status of the wet-pipe fire sprinkler inerting system for transmission by the communications module.

According to another aspect of the present disclosure, the logic determining device is further configured to generate a status report for the wet-pipe fire sprinkler inerting system based on the analysis of the sensor data conducted by the logic determining device.

According to another aspect of the present disclosure, the receiving device is configured to analyze the sensor data and determine a status of the wet-pipe fire sprinkler system.

According to another aspect of the present disclosure, the communications module includes at least one of a wired connection and a wireless connection with a receiving device.

According to another aspect of the present disclosure, the wired connection includes one or a combination of serial or ethernet communication.

According to another aspect of the present disclosure, the wireless connection includes at least one or a combination of Bluetooth, Bluetooth Low Energy, Wi-Fi, Cellular 3G/4G/5G, or Low-Power Wide Area Networking.

According to another aspect of the present disclosure, the at least one sensor includes at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system. a flow sensor in fluid communication with the nitrogen gas source, an oxygen sensor in fluid communication with the piping network of the wet-pipe fire sprinkler system, and an oxygen sensor in fluid communication with the nitrogen gas source.

According to another aspect of the present disclosure, the control system is configured to automate a wet-pipe inerting process, by executing computer-readable instructions which cause the logic determining device, in coordination with the at least one sensor to perform the steps of determining if the wet-pipe fire sprinkler system has been drained; wherein if the system has not been drained a drain valve of the wet-pipe fire sprinkler system is opened; confirming a drain valve of the wet-pipe fire sprinkler system is closed upon confirmation that the wet-pipe fire sprinkler system has been drained, wherein if the system detects that the drain valve is open the logic determining device commands the drain valve closed; opening a nitrogen supply valve to allow nitrogen to flow into the wet-pipe fire sprinkler system; monitoring a pressure within the wet-pipe fire sprinkler system; measuring an oxygen level within the wet-pipe fire sprinkler system and determining if the measured oxygen level is below a threshold oxygen level; closing the nitrogen supply valve when the pressure within the wet-pipe fire sprinkler system reaches a threshold pressure or oxygen level; monitoring a pressure within the wet-pipe fire sprinkler system and determining if an exhaust valve of the wet-pipe fire sprinkler system needs to be actuated to drain an amount of the gas mixture from the wet-pipe fire sprinkler system; wherein the exhaust valve may comprise the drain valve, an air vent, or a combination thereof and if required the exhaust valve is opened only for the duration required to drain the amount of the gas mixture from the system; repeating the above steps if the measured oxygen level is not below the threshold oxygen level; and recording the sensor data during the inerting process and, upon completion of the inerting process, generating a report from the sensor data.

According to another aspect of the present disclosure, the control system is also configured to generate a report from the at least one sensor confirming initiation and completion of the wet-pipe inerting process and noting any deviation from the wet-pipe inerting process and transmit the report to the receiving device via the communications module.

According to another aspect of the present disclosure, the control system is configured to monitor a wet-pipe inerting process, by executing computer-readable instructions which cause the logic determining device, in coordination with the at least one sensor to perform the steps of: receiving the sensor data in the logic determining device, wherein the at least one sensor comprises at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system, a flow sensor in fluid communication with the nitrogen gas source, an oxygen sensor in fluid communication with the piping network of the wet-pipe fire sprinkler system, and an oxygen sensor in fluid communication with the nitrogen gas source; recording the sensor data within the memory module; and transmitting the sensor data to at least one of the receiving device and the user interface.

According to another aspect of the present disclosure, there is provided a system for automating a wet-pipe inerting process for a wet pipe fire sprinkler inerting system that includes one or more control systems as described herein in common communication with a central hub.

According to another aspect of the present disclosure, there is provided a system for automating a wet-pipe inerting process for a wet pipe fire sprinkler inerting system that includes one or more control systems as described herein in common communication with a wired or wireless network.

According to another aspect of the present disclosure, there is provided a method of automating a wet-pipe inerting process for a wet-pipe fire sprinkler system, including the steps of: connecting a control system with the wet-pipe fire sprinkler system, the control system including: a logic determining device; a user interface in communication with the logic determining device and configured to display a status of the wet-pipe fire sprinkler system; at least one sensor configured to monitor at least one operating parameter of the wet-pipe fire sprinkler system and wherein the at least one sensor is in communication with the logic determining device and configured to transmit a signal to the logic determining device with sensor data relating to the at least operating parameter; a memory module in communication with the logic determining device and configured to record the sensor data; a communications module in communication with the logic determining device and configured to transmit the sensor data to a receiving device; and a power module configured to deliver power for the control system; inerting the wet-pipe fire sprinkler system, including the steps of: determining if the wet-pipe fire sprinkler system has been drained, wherein if the system has not been drained a drain valve of the wet-pipe fire sprinkler system is opened; confirming a drain valve of the wet-pipe fire sprinkler system is closed upon confirmation that the wet-pipe fire sprinkler system has been drained; wherein if the system detects that the drain valve is open the logic determining device commands the drain valve closed; opening a nitrogen supply valve to allow nitrogen to flow into the wet-pipe fire sprinkler system; monitoring a pressure within the wet-pipe fire sprinkler system; measuring an oxygen level within the wet-pipe fire sprinkler system and determining if the measured oxygen level is below a threshold oxygen level; closing the nitrogen supply valve when the pressure within the wet-pipe fire sprinkler system reaches a threshold pressure or oxygen level; monitoring a pressure within the wet-pipe fire sprinkler system and determining if an exhaust valve of the wet-pipe fire sprinkler system needs to be actuated to drain an amount of the gas mixture from the wet-pipe fire sprinkler system; wherein the exhaust valve may comprise the drain valve, an air vent, or a combination thereof and if required the exhaust valve is opened only for the duration required to drain the amount of the gas mixture from the system; repeating the above steps if the measured oxygen level is not below the threshold oxygen level; and recording the sensor data during the inerting process and, upon completion of the inerting process, generating a report from the sensor data.

According to another aspect of the present disclosure, the method of automating a wet-pipe inerting process also includes generating a report from the at least one sensor confirming initiation and completion of the wet-pipe inerting process and noting any deviation from the wet-pipe inerting process and transmitting the report to the receiving device and/or the user interface.

According to another aspect of the present disclosure, the method of automating operation of an inerting system also includes transmitting the sensor data and the report to the receiving device and/or the user interface.

According to another aspect of the present disclosure, the method of automating a wet-pipe inerting process includes receiving the sensor data in the logic determining device, wherein the at least one sensor comprises at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system, a flow sensor in fluid communication with the nitrogen gas source, an oxygen sensor in fluid communication with the piping network of the wet-pipe fire sprinkler system, and an oxygen sensor in fluid communication with the nitrogen gas source; recording the sensor data within the memory module; and transmitting the sensor data to at least one of the receiving device and the user interface.

According to another aspect of the present disclosure, the method of automating a wet-pipe inerting process includes the steps of comparing the sensor data with at least one threshold operating parameter stored in the memory module; identifying non-compliant sensor data falling outside of the at least one threshold operating parameter; and generating a signal indicative of the non-compliant sensor data and transmitting the signal to at least one of a receiving device and the user interface.

According to another aspect of the present disclosure, the method of automating a wet-pipe inerting process includes the steps of removing the control system from the wet-pipe fire sprinkler interting system and transporting the control system to another wet-pipe fire sprinkler inerting system.

According to another aspect of the present disclosure, there is provided a method of monitoring a wet-pipe inerting process for a wet-pipe fire sprinkler, including the steps of connecting a control system with the wet-pipe fire sprinkler system, the control system including: a logic determining device; a user interface in communication with the logic determining device and configured to display a status of the wet-pipe fire sprinkler system; at least one sensor configured to monitor at least one operating parameter of the wet-pipe fire sprinkler system and wherein the at least one sensor is in communication with the logic determining device and configured to transmit a signal to the logic determining device with sensor data relating to the at least operating parameter; a memory module in communication with the logic determining device and configured to record the sensor data; a communications module in communication with the logic determining device and configured to transmit the sensor data to a receiving device; and a power module configured to deliver power for the control system; receiving the sensor data in the logic determining device; recording the sensor data within the memory module; and transmitting the sensor data to at least one of the receiving device and the user interface.

According to another aspect of the present disclosure, the method of monitoring a wet-pipe inerting process also includes generating a report from the at least one sensor confirming initiation and completion of the wet-pipe inerting process and noting any deviation from the wet-pipe inerting process and transmitting the report to the receiving device and/or the user interface.

According to another aspect of the present disclosure, the method of monitoring a wet-pipe inerting process also includes transmitting the sensor data and the report to the receiving device and/or the user interface.

According to another aspect of the present disclosure, the method of monitoring a wet-pipe inerting process, wherein the at least one sensor comprises at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system, a flow sensor in fluid communication with the nitrogen gas source, an oxygen sensor in fluid communication with the piping network of the wet-pipe fire sprinkler system, and an oxygen sensor in fluid communication with the nitrogen gas source.

According to another aspect of the present disclosure, the method of monitoring a wet-pipe inerting process includes comparing the sensor data with at least one threshold operating parameter stored in the memory module; identifying non-compliant sensor data falling outside of the at least one threshold operating parameter; and generating a signal indicative of the non-compliant sensor data and transmitting the signal to at least one of a receiving device and the user interface.

According to another aspect of the present disclosure, the method of monitoring a wet-pipe inerting process includes the steps of removing the control system from the wet-pipe fire sprinkler interting system and transporting the control system to another wet-pipe fire sprinkler inerting system.

These aspects are merely illustrative of the innumerable aspects associated with the present disclosure and should not be deemed as limiting in any manner. These and other aspects, features and advantages of the present disclosure will become apparent from the following detailed description when taken in conjunction with the referenced drawings.

### BRIEF DESCRIPTION OF THE DRAWINGS

FIG. 1 is a schematic view of a fire sprinkler system with a WPNI control system.

FIG. 2A is a front view of a WPNI control system according to an embodiment of the present disclosure.

FIG. 2B is a right-side view of the WPNI control system in FIG. 2A.

FIG. 2C is a left side view the WPNI control system in FIG. 2A.

FIG. 3 is a cross-sectional view of the WPNI control system of FIG. 2B taken along line A-A.

FIG. 4 is a flowchart of the monitoring, logging, and reporting process for a WPNI control system according to an embodiment of the present disclosure.

FIG. 5 is a flowchart of the automation of a WPNI process implemented by a control system of the present disclosure.

FIG. 6A is a front view of a WPNI control system according to an embodiment of the present disclosure.

FIG. 6B is a left side view of the WPNI control system in FIG. 6A.

FIG. 6C is a right side view the WPNI control system in FIG. 6A.

FIG. 7A is a schematic view of a multi-zone fire sprinkler system with multiple WPNI control systems, a single nitrogen source, and a central hub.

FIG. 7B is a schematic view of a multi-zone fire sprinkler system with multiple WPNI control systems and multiple nitrogen sources.

FIG. 7C is a schematic view of a multi-zone fire sprinkler system with multiple WPNI control systems and a single nitrogen source.

FIG. 8A is a front view of a central hub according to an embodiment of the present disclosure.

FIG. 8B is a left side view of the central hub in FIG. 8A.

FIG. 8C is a right side view the central hub in FIG. 8A.

FIG. 9 is a cross-sectional view of the central hub of FIG. 8C taken along line C-C.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

Generally, all terms used in the claims are to be interpreted according to their ordinary meaning in the technical field, unless explicitly defined otherwise herein. All references to a/an/the element, apparatus, component, means, step, etc., are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first,” “second,” etc., for different features/components of the present disclosure are only intended to distinguish the features/components from other similar features/components and not to impart any order or hierarchy to the features/components.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles, or systems described herein may be used in a number of directions and orientations.

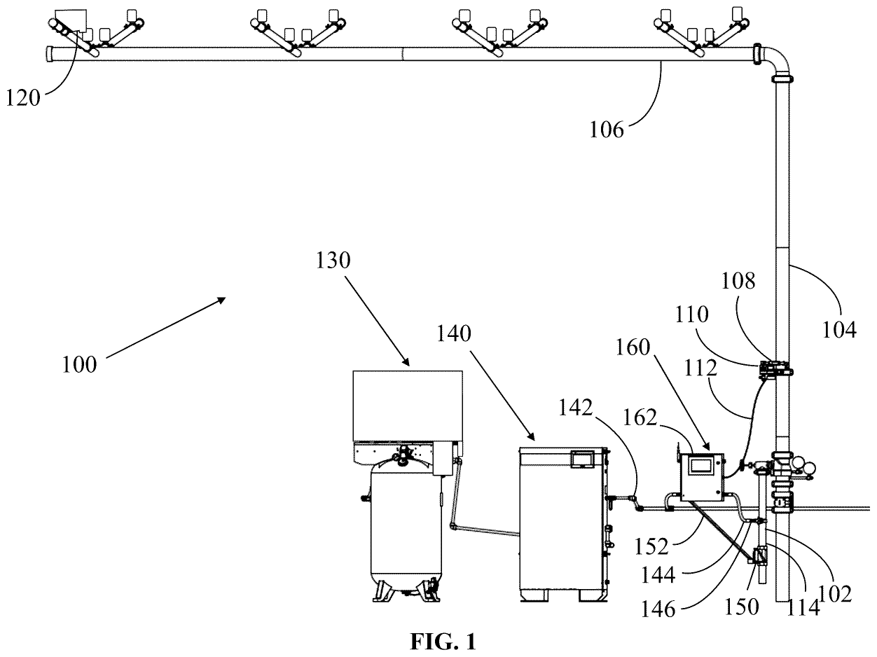

FIG. 1 illustrates a wet-pipe fire sprinkler system 100 with a control system 160, capable of monitoring and automating a WPNI process or operation of the wet-pipe fire sprinkler system 100. The control system 160 can be integrated into existing wet-pipe fire sprinkler systems 100 or installed as a component of a new wet-pipe fire sprinkler system 100. The wet-pipe fire sprinkler system 100 shown in FIG. 1 contains an air compressor 130 connected with piping to a nitrogen source 140. The nitrogen source 140 may include any type of nitrogen generator known in the art, such as a nitrogen membrane system, nitrogen pressure swing adsorption system, or the like. Alternatively, nitrogen source 140 may be in the form of a cylinder of compressed nitrogen gas or similar vessel for containing or otherwise supplying pressurized gas to the system. Alternatively, nitrogen source 140 may be a connection to a nitrogen system if one is used in the facility in which the sprinkler system 100 is located. Alternatively, nitrogen source 140 may be a transportable nitrogen generator of the type disclosed in commonly assigned U.S. patent application Ser. No. 61/383,546, filed Sep. 16, 2010, by Kochelek et al., the disclosure of which is hereby incorporated herein by reference.

During the WPNI process, the control system 160 commands a drain valve 150 to open. The drain valve 150 is connected to the sprinkler system 100 through a drainpipe 102, and once open will drain any water contained in the sprinkler system 100. In the illustrated embodiment the drainpipe 102 is connected to a lower end of a vertical riser 104. In the depicted embodiment once the drainpipe 150 is opened, the gravitational force on the water contained in the sprinkler system 100 will cause the system to drain. In another embodiment the drainpipe 102 may be located elsewhere in the fire sprinkler system 100. The illustrated embodiment depicts a controlled drain valve 150 which can be actuated by the control system 160 via a drain connection 152. In another embodiment the drain valve 150 is not connected to the control system 160 and is actuated manually by an operator to drain the fire sprinkler system 100. In yet another embodiment the drain valve 150 is controlled wirelessly by the control system 160.

In some embodiments, a pressure sensor may be provided in the fire sprinkler system 100 to detect a drop in pressure within the system 100 resulting from the system 100 being draining. In alternate embodiments, a liquid sensor may be installed within the fire sprinkler system 100, in combination with or instead of a pressure sensor, in order to detect the presence of water in the system 100. The pressure sensor and/or liquid sensor may be used by the control system 160 to verify the system has been drained.

Wet-pipe fire sprinkler system 100 comprises a nitrogen source supply line 142 connecting the nitrogen source 140 to the control system 160. Once the wet-pipe sprinkler system 100 has been drained, the control system 160 allows nitrogen gas to pass through a control system enclosure 162 to a control system supply line 144 in order to pressurize the wet-pipe fire sprinkler system 100. In some embodiments the nitrogen gas is routed outside of the control system 160 and any sensors are placed externally as well and communicate status to the control system 160. Nitrogen gas is supplied to the wet-pipe fire sprinkler system 100 until a predetermined pressure within the wet-pipe fire sprinkler system is measured. In some embodiments the predetermined pressure is 30 psig. In other embodiments nitrogen gas is supplied until a threshold oxygen level is reached in the system 100. The pressure of the wet-pipe fire sprinkler system 100 is measured by a pressure sensor 108 connected to the sprinkler system 100 adjacent to a gas port 110. In other embodiments the pressure sensor 108 may be located anywhere within the fire sprinkler system 100.

In another embodiment, a flow sensor 114 is installed in the wet-pipe fire sprinkler system 100 to measure the flow of gas or water entering or exiting the wet-pipe fire sprinkler system 100, in addition to the pressure sensor 108. In some embodiments in which the control system 160 is connected directly with the wet-pipe sprinkler system 100, a valve 146 may be provided, for example, within the control system enclosure 162 in the control system supply line 144, or any other suitable location, to prevent any water contained within the wet-pipe fire sprinkler 100 from flowing into the control system 160 or nitrogen source 140. The valve may, for example, be a check valve or float valve or switch. In some embodiments, the valve 146 may be located within the wet-pipe fire sprinkler system 100 and in communication with the control system 160 to confirm whether any water ingress is currently occurring. The terms “control system” and “communication” herein are intended to encompass various means of logic control, including electronic, fiber optic, or pneumatic systems, for example. In the case of water ingress, the control system 160 could maintain the nitrogen supply valve in a closed position, only allowing the control system 160 to open any nitrogen supply valves when water ingress is not a risk. In further aspects of the system, a combination or series of valves may be used to prevent backflow of water into the control system 160.

Wet-pipe fire sprinkler system 100 further comprises gas port 110 connected to the vertical riser 104. In other embodiments the gas port 110 is connected to a horizontal main 106 or any other section of the system in fluid communication with the vertical riser 104 and horizontal main 106. Gas port 110 is connected with the control system 160 by a sample line 112. In another embodiment the gas port 110 is connected to an oxygen sensor installed in the facility that transmits data to the control system 160. In the illustrated embodiment an oxygen sensor, which may be located within the control system enclosure 162, measures the oxygen content of a gas sample diverted to the control system 160 from the gas port 110. The reading of the gas sample can be used by the control system 160, or an operator if manual intervention is necessary for any reason, to determine when the wet-pipe fire sprinkler system 100 has reached a desired nitrogen/oxygen ratio and when the inerting process may be stopped. The illustrated embodiment of FIG. 1 depicts an exhaust valve comprising the air vent 120 in the horizontal main 106. In other embodiments the exhaust valve may be located anywhere within the fire sprinkler system 100 that is in fluid communication with the horizontal main 106 and the vertical riser 104. In other embodiments the exhaust valve comprises the drain valve 150 and the air vent 120 may comprise a pressure relief valve. In yet another embodiment the exhaust valve may be both the air vent 120 and the drain valve 150. The exhaust valve allows for air within the system 100 to be vented when the pressure reaches a predetermined level during a nitrogen fill or the control system 160 determines that pressure in the system needs to be reduced. In some embodiments the air vent 120 will remain open during pressurization of the system, in one version of this the air vent 120 remains fully open and the system undergoes a nitrogen purge sequence. In another embodiment the air vent 120 comprises an orifice restriction that allows the system 100 to be filled with nitrogen faster than it can be vented off. In some embodiments the air vent 120 comprises an electronically controlled valve in wired or wireless communication with the control system 160 to allow the control system 160 to actuate the air vent 120 directly.

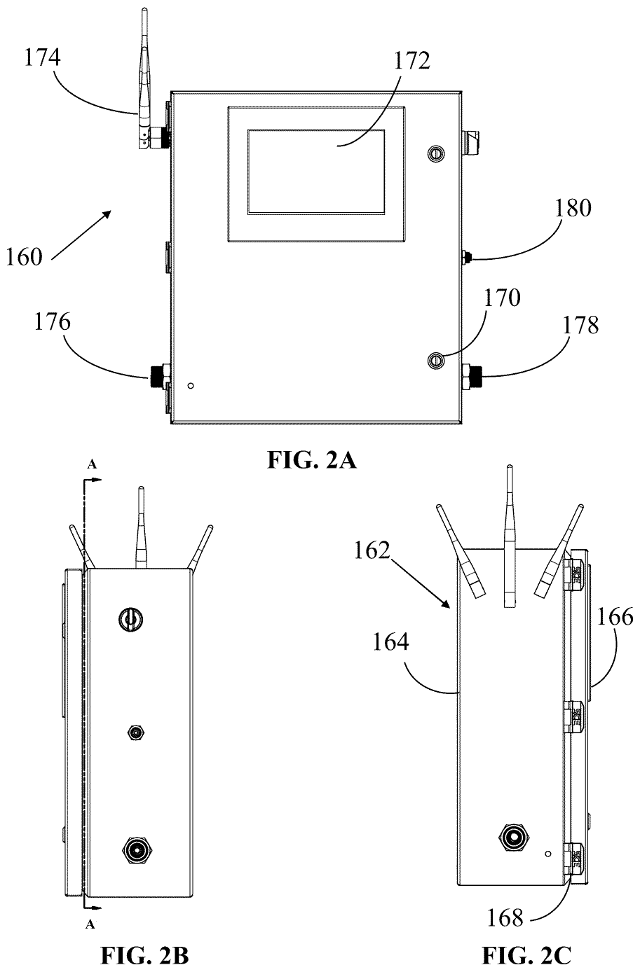

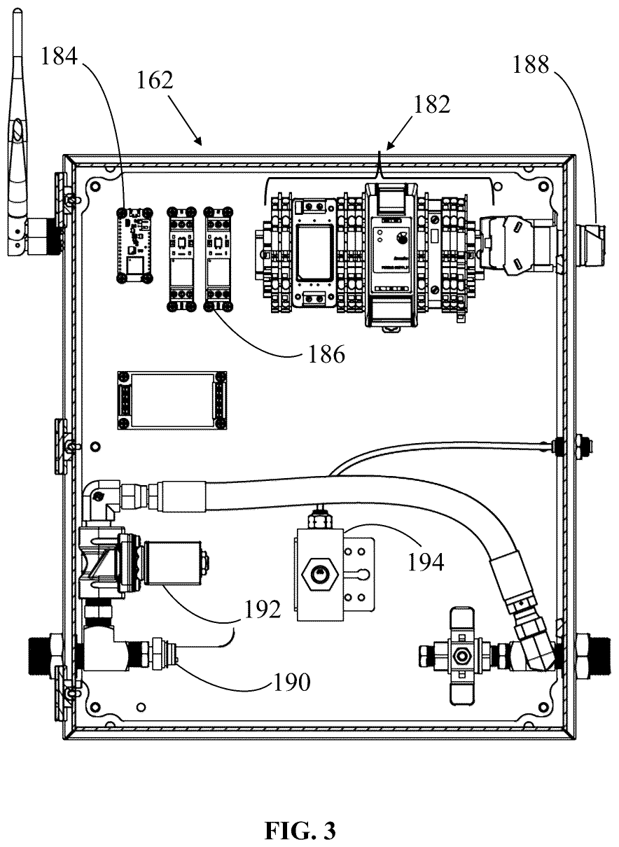

FIGS. 2A to 3 depict front, side, and section views of the control system 160. The enclosure 162 comprises a control system box 164, an enclosure lid 166, hinges 168, and captive fasteners 170. The control system box 164 forms the cavity shown in the section view in FIG. 3 that contains all of the control system components. The control system box 164 is covered with the enclosure lid 166 which in the illustrated embodiment is fixed to the control system box 164 by the hinges 168. The lid is held closed by the captive fasteners 170. In other embodiments the enclosure lid 166 is secured to the control system box 164 using only captive fasteners 170, or any other type of structural configuration known in the art. A user interface 172 may be incorporated into the enclosure 162 or located remotely from the enclosure 162. The illustrated embodiment of FIG. 2A depicts a touchscreen as the user interface 172. In other embodiments the user interface 172 may be an LCD display, status indicator lights, physical buttons, or any other type of display and interface known in the art. In some embodiments the user interface 172 may display data recorded from various sensors within the system. In further aspects the user interface 172 may allow a user to adjust parameters such as, but not limited to, set delays during automation, pressure thresholds, alarm settings or thresholds, or time intervals between sensor measurements.

Some embodiments may incorporate remote access wherein the user interface 172 may be provided remotely via a networked portal, website, online portal, or application accessible from any device that is connectable via wired or wireless communication, for example, WAN or LAN, Wi-Fi, Bluetooth, BLE, or other methods, that could pair with the control system 160.

In the illustrated embodiment and other embodiments incorporating remote access, the enclosure 162 further comprises a communication module 174. In the illustrated embodiments of FIG. 2A-3 the communication module 174 is depicted as a set of antennas for wireless communication. In some embodiments the communication module 174 is capable of wireless communication consisting of, but not limited to, one or a combination of Bluetooth, Bluetooth Low Energy, Wi-Fi, Cellular 3G/4G/5G, or Low-Power Wide Area Networking (LoRaWAN/NB-IoT/Sigfox/Wize/LTE-M). In another embodiment the communication module 174 is a wired connection consisting of, but not limited to, one or a combination of serial or ethernet communication such as I2C, SPI, UART, RS-232, RS-485, Modbus, and CANbus. In yet another embodiment, the communication module 174 comprises wired or both wired and wireless communication capabilities. The communication module 174 enables the control system 160 to transmit and receive data with a remote location such as a remote computer, server, or interface for a cloud computing service. Additionally, the communication module 174 may wirelessly interface with sensors installed in the wet-pipe fire sprinkler system 100 outside of the control system enclosure 162.

The illustrated embodiment of FIG. 3 depicts a logic determining device 184, a power module 182, relays 186, and a power switch 188. The logic determining device 184 may comprise a processor, microcontroller, programmable logic controller (PLC), or pneumatic controller, for example, and the presence of other components described herein may change with the type of logic determining device that is used. Further, while the various control components are described in the illustrated embodiments as discrete components, they may also be provided as single, multi-function units as appropriate.

In the illustrated embodiment of FIG. 3 the power module 182 is depicted as internal to the control system enclosure 162. In other embodiments the power module 182, may be located externally to the control system enclosure 162 and provide power to control system 160 through a wired connection. In further embodiments the power module 182 encompasses an internal or external backup battery to ensure the system does not lose power in case of an outage. The power module 182 may be a direct connection to facility power or a DC power supply. In other embodiments the power module 182 may comprise multiple power supplies to supply different voltages. In the illustrated embodiment of FIG. 3 the relays 186 are installed on PCBs separate from the logic determining device. In other embodiments the relays 186 may be installed along a DIN rail. In some embodiments the relays 186 may be installed on a PCB with the logic determining device 184 and power module 182. In this embodiment the logic determining device 184 sends a signal to the relays 186 to control devices such as valves or switches. In some embodiments the logic determining device 184 monitors the status of contacts on the relays 186 to determine the state of other system components such as valves, sensors, or switches. In other embodiments the relay 186 contacts are used to satisfy interlocks and status indicators for panels outside of the control system 160, such as a fire alarm control panel or a building monitoring system. The power switch 188 depicted in FIG. 3 allows an operator to manually turn on or off the control system 160.

Facility power and sensor wires are brought into the control system enclosure 162 through knockouts along the sides. These knockouts provide openings in the control system enclosure 162 where power and other inputs or outputs can be routed to components or terminal blocks within the control system enclosure 162. In other embodiments the analog outputs are sent from the logic determining device 184 or various other components through the knockouts to a building monitoring system.

In some embodiments the control system 160 may contain a memory module. The memory module may be located internal to the control system enclosure 162 or in other embodiments may be external and located in a remote component such as a computer, server, or a cloud computing service. The logic determining device 184 uses the memory module to store data as well as store data recorded from sensors that will be required for analysis.

In the illustrated embodiment of FIG. 3 the logic determining device 184 is depicted inside the control system enclosure 162. In another embodiment the logic determining device 184 may be external to the control system enclosure 162 and located in a remote component such as a computer, remote server, or a cloud computing service.

The illustrated embodiment of FIGS. 2A-3 comprises a nitrogen supply inlet 176 and a nitrogen supply outlet 178 in order to allow nitrogen to flow from the nitrogen source 140 through the control system 160. In another embodiment nitrogen is routed outside of the control system 160 and the following components are located externally. The enclosure 162 contains a nitrogen supply pressure sensor 190 and a nitrogen supply valve 192 connected between the nitrogen supply inlet 176 and the nitrogen supply outlet 178. In some embodiments the nitrogen supply pressure sensor 190 may be located anywhere between the nitrogen source and the fire sprinkler system. The nitrogen supply pressure sensor 190 enables a logic determining device 184 to record and monitor the pressure supplied from the nitrogen source 140.

The nitrogen supply valve 192 controls if nitrogen gas is sent to the wet-pipe fire sprinkler system 100. In some embodiments the nitrogen supply valve 192 may be manually controlled by the user. In other embodiments the nitrogen supply valve 192 may be electronic or pneumatic and controlled by outputs from the logic determining device 184. Any pneumatic valves may utilize facility gas or be connected to the nitrogen source.

In another embodiment a nitrogen flow sensor is installed inside of the control system enclosure 162 between the nitrogen supply inlet 176 and outlet 178. The logic determining device 184 is configured to record and log the output of the nitrogen flow sensor to determine the flow rate of nitrogen from the nitrogen source 140. In another embodiment the nitrogen flow sensor is located external to the control system enclosure 162.

In yet another embodiment an oxygen sensor is installed inside of the control system enclosure 162 between the nitrogen supply inlet 176 and outlet 178. The oxygen sensor is utilized by the logic determining device 184 to measure the oxygen content of the supplied nitrogen. The oxygen content of the nitrogen source may be utilized to monitor operation of the nitrogen source 140 or in comparison with the data recorded by a wet-pipe oxygen sensor 194. In systems in which the nitrogen source 140 allows for variable nitrogen purity levels, the oxygen content readings can be used to confirm that the nitrogen source 140 is operating within the expected purity parameters. In the illustrated embodiment of FIG. 3 the wet-pipe oxygen sensor is contained within the control system enclosure 162 and connects to an oxygen sampling port 180 which connects to the wet-pipe sprinkler system as shown in FIG. 1. In some embodiments the oxygen sensor and oxygen sampling port 180 are located externally to the control system enclosure 162.

In yet another embodiment one or more further flow control valves are provided to maintain a desired flow rate of gas or liquid to the various system sensors to provide stable measurement conditions.

In some embodiments of the present disclosure, the components of the control system described herein may configured for temporary installation with a wet-pipe fire sprinkler system and subsequent removal for installation and use with other wet-pipe fire sprinkler systems. These “mobile” embodiments provide flexibility for installation and maintenance contractors in performing their services for facility owners and managers. Other embodiments may involve fixed control system components for longer term use with a particular wet-pipe fire sprinkler system.

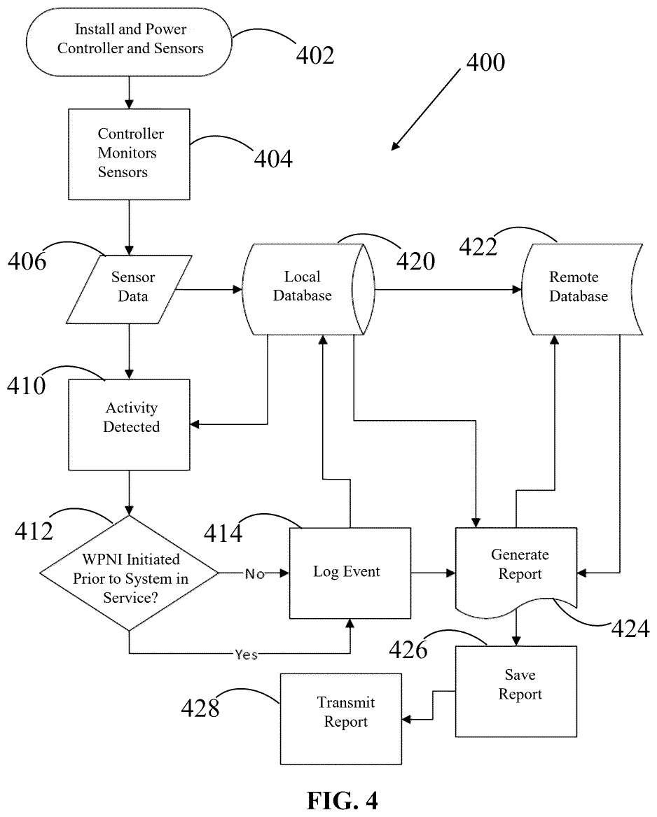

Referring now to FIG. 4 a flowchart 400 is shown depicting an exemplary monitoring, logging, and reporting logic of embodiments of the present disclosure. Although flowchart 400 provides discrete steps in a set order, a person of skill in the art will recognize on reading the disclosure that each step described may further be broken into several additional steps not specifically described and/or certain described steps may be combined into a single operation. The process starts with step 402 where the control system 160 and all relevant sensors are configured and powered on via the power module. Once the system is started, the control system 160 progresses to step 404 and enters monitoring mode. The logic determining device 184 of the control system 160 monitors the sensors for activity and accumulates the sensor data of step 406. As described by step 420 the accumulated sensor data is stored in a memory module in a local database. Additionally, in some embodiments step 422 is executed wherein at predetermined but adjustable time intervals sensor data is also stored in a remote database. In some embodiments the control system 160 skips step 420 and only stores the accumulated sensor data in a remote database. At step 410 the logic determining device detects a change in the system status based on the monitored sensor data. At step 412 the logic determining device checks system logs to determine if the user has initiated a WPNI process via the user interface. This is recorded in the details of the event that is logged in 414 in order to provide information on if the detected activity was expected. At step 424 the stored sensor data and logged events are accumulated to generate a report for a stakeholder such as an operator or building owner confirming initiation and completion. In some embodiments the report is generated locally on the logic determining device. In other embodiments the report is generated by a remote cloud service. In some embodiments the report discloses deviations from the inerting process such as an incomplete step. At step 426 the report is saved to the memory module. Finally in step 428 via the communications module the generated report is sent to the stakeholders.

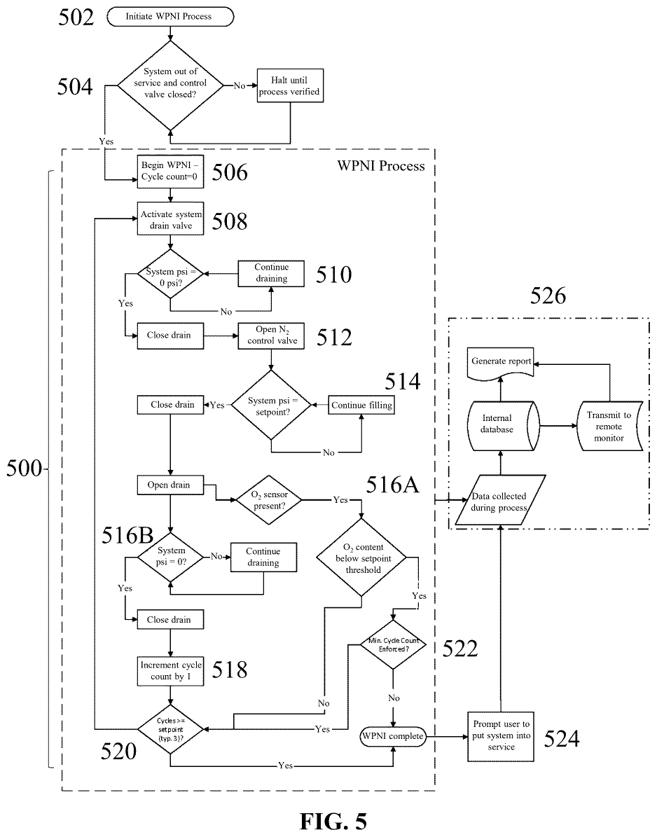

Referring now to FIG. 5 a flowchart is shown depicting the automation of the WPNI process for a sprinkler system. Embodiments of manual versions of the WPNI process are described in U.S. Pat. No. 9,526,933, the entire disclosure of which is incorporated herein by reference. Although the flowchart of FIG. 5 provides discrete steps in a set order, a person of skill in the art will recognize on reading the disclosure that each step described may further be broken into several additional steps not specifically described and/or certain described steps may be combined into a single operation. A user requests initiation of the automated WPNI process 502. The system requests confirmation from the user that the system is out of service and that the control valve is closed and will not proceed with the WPNI process until the user provides such confirmation 504. The control system 160 checks the status and if need be resets a cycle counter, referring to iterations of the filling/draining process associated with embodiments of the inerting process, to zero 506. In some embodiments the cycle counter is reset at the end of the process prior to step 524. The portion of the flowchart within the dashed line 500 represents the exemplary steps of the WPNI process, which are iterative and repeated until a desired oxygen level has been achieved. Once the WPNI process is started the logic determining device reviews sensor data to determine if the wet-pipe system has been drained and opens the system drain valve if the user has not already drained the system 508. Upon confirming that the system has been drained, the control system 160 closes the system drain.

The control system 160 opens a supply valve in the nitrogen supply line to allow a flow of nitrogen into the system 512. The control system 160 monitors the pressure within the system through signals transmitted by pressure sensors and maintains the nitrogen supply valve in an open position until a desired system setpoint pressure is reached, at which time the control system 160 closes the nitrogen supply valve to stop the flow of nitrogen into the system 514.

In embodiments of the system incorporating an oxygen sensor, the control system 160 may transmit a signal to the oxygen sensor to obtain a reading of the oxygen level within the system 516A. If the oxygen level is below a threshold setpoint, the WPNI process may be considered to be complete. If the oxygen level is still above the threshold setpoint, the process is repeated starting with the control system 160 opening the system drain again 506. In some embodiments the oxygen reading is conducted during the nitrogen fill that occurs in step 512.

In embodiments of the system incorporating a cycle counter, the cycle counter may be advanced by one to track completion of one cycle of filling/draining 518. In embodiments with or without an oxygen sensor, the control system 160 may be programmed to require completion of a set number of cycles of draining/filling before the WPNI process is considered to be complete 520. In embodiments incorporating an oxygen sensor, the draining/filling process may be required to continue even if the oxygen level is below the threshold setpoint if the minimum cycle count is enforced and not yet met 522.

Upon competition of the WPNI process 500 as determined by measured oxygen level and/or cycle count, the control system 160 prompts the user to place the system back into service 524. In some embodiments the control system 160 resets the cycle counter as well. The control system 160 also transmits data collected during the WPNI process to a database for generation of a process report or transmission to a remote monitoring station 526. The control system 160 may transmit the WPNI process data in a batch following conclusion of the WPNI process or continuously or periodically during the operation of the WPNI process.

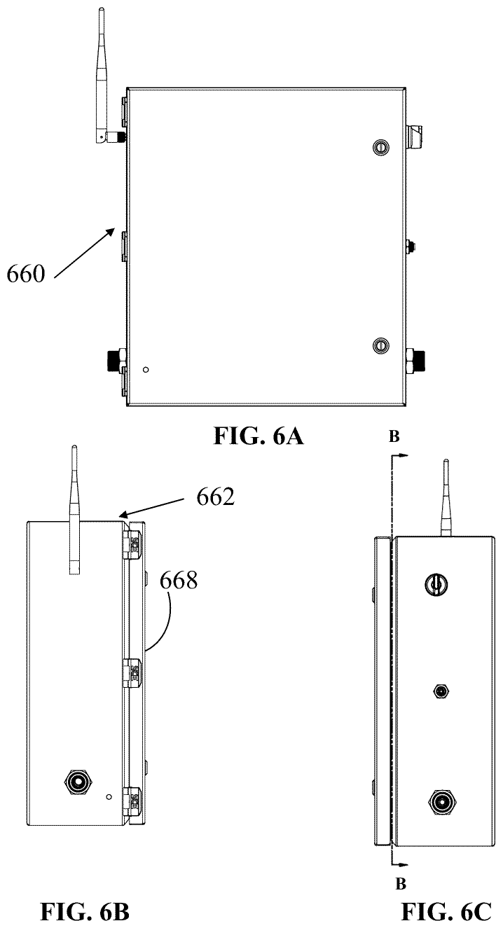

Another embodiment of a control system 660 is described with reference to FIGS. 6A-6C. The illustrated embodiment is similar to the control system 160 described above but does not have a user interface integrated into an enclosure lid 668 of the control system enclosure 662. Therefore, the description will generally discuss the main differences. The illustrated embodiment may be used with the previously described mobile user interface. In another embodiment, the control system 660 may be combined with a plurality of other control systems each tied to a different zone of a multi-zone wet-pipe fire sprinkler system or to multiple sprinkler systems within a building containing multiple wet-pipe fire sprinkler systems. The plurality of control systems may each communicate with a singular central hub for coordinating monitoring and control.

Alternatively, the plurality of control systems 760 may be interconnected for communication via a wired or wireless network without a central hub. For example, a control system connected to the network may communicate a status of the associated system or zone with other control systems in the network, thereby allowing modification of settings for another control system via a single user interface. For example, user access to one control system in the network provides access to another or all other control systems in the network.

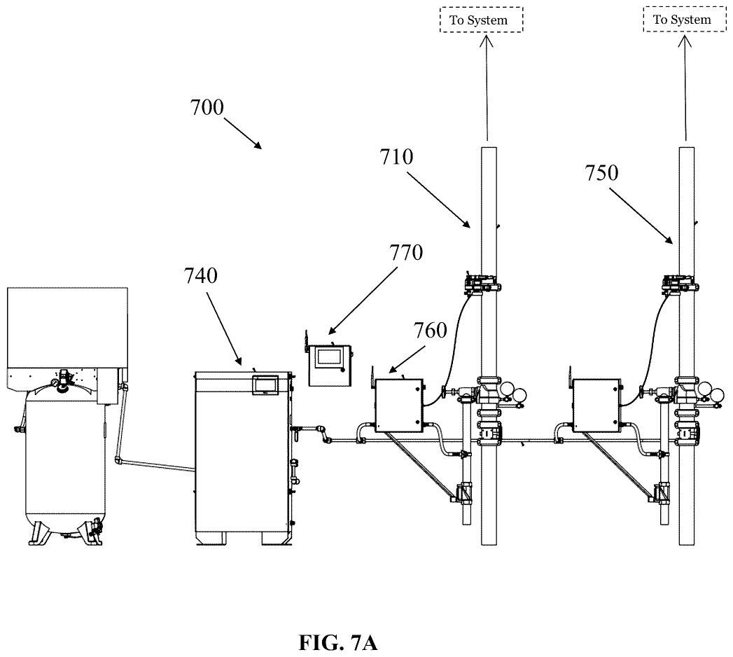

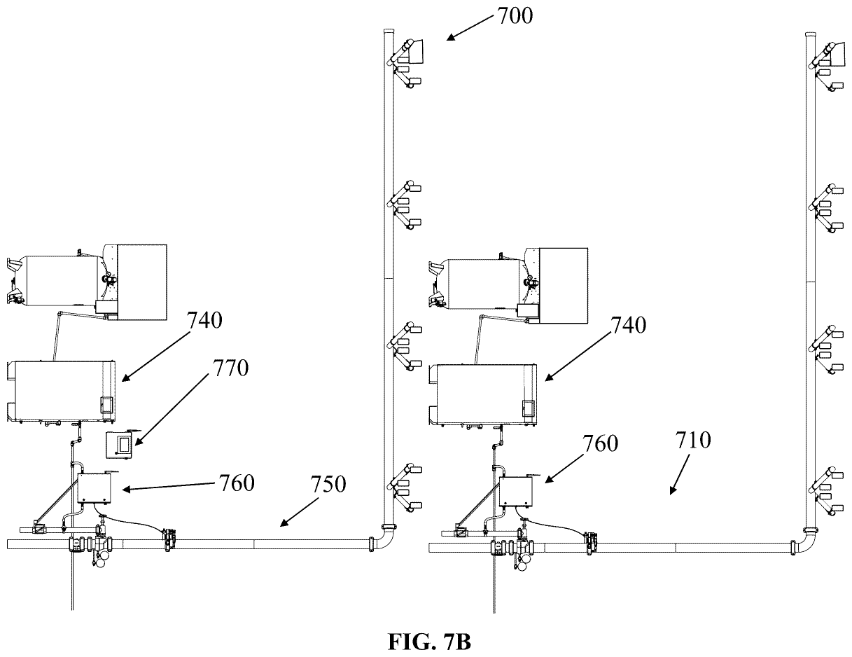

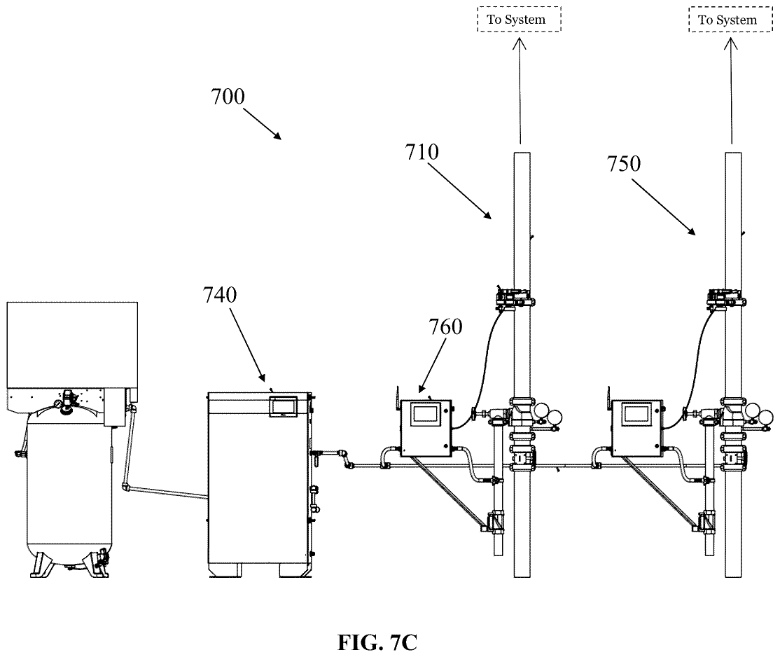

Referring to FIG. 7A-7C a multi-zone sprinkler system 700 is shown. The illustrated embodiments are similar to the wet-pipe fire sprinkler system 100 described above but include two separate wet-pipe fire sprinkler systems 710, 750. The embodiment would be essentially the same for a single system incorporating multiple zones rather than completely separate systems. Therefore, the description will generally discuss the main differences. In the embodiment shown in FIGS. 7A and 7B each of the systems 710, 750 are provided with a separate control system 760 the communicate with a central hub 770. FIGS. 7A and 7B show the central hub 770 in relative proximity to on of the systems 710, 750, however, this is merely for purposes of illustration. The central hub 770 may be remotely located from both systems 710, 750 or incorporated into one of the systems. In some embodiments, the central hub 770 may be incorporated into one of the control systems 760. In some embodiments, the control system 760 may function independently without the need for a central hub 770 as shown in FIG. 7C where each system 710, 750 has its own control system 760. The various system control systems 760 be interconnected for communication via a wired or wireless network without a central hub. In embodiments including a central hub 770, the control systems 760 may be provided with a wired or wireless connection with the central hub 770. As shown in FIGS. 7A and 7C a single nitrogen source 740 may be utilized for multiple sprinkler systems 710, 750. Another embodiment depicted in FIG. 7B shows a separate nitrogen source for each system.

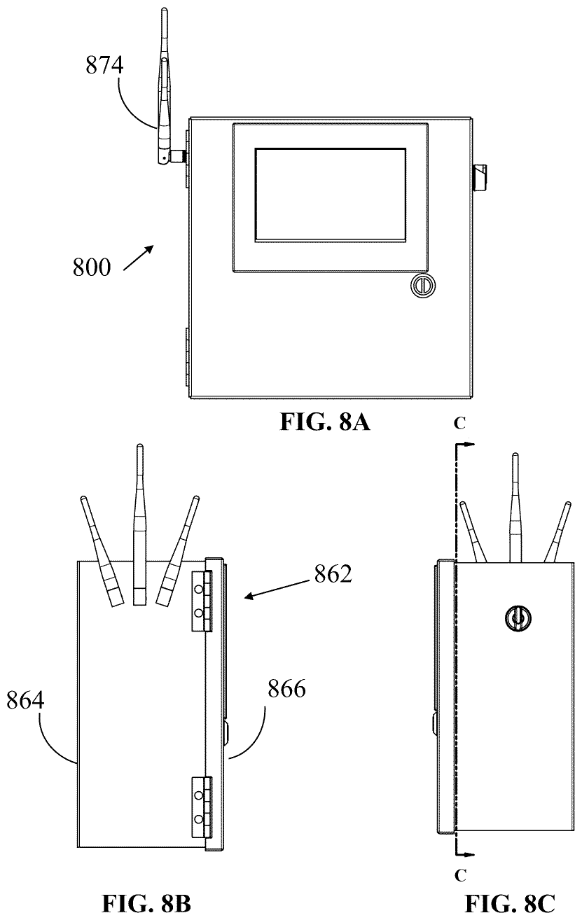

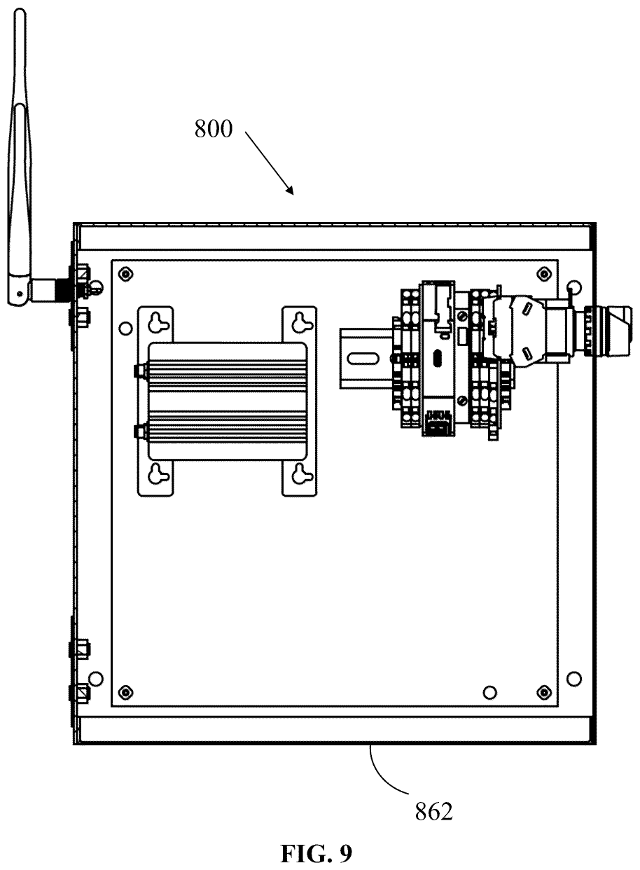

FIGS. 8A to 9 depict front, side, and section views of an embodiment of a central hub 770. The central hub 770 may be configured as a bridge to a remote or cloud monitoring service. The central hub 770 may accumulate process and monitoring data for both systems 710, 750 from each control system 760 and transmit the data to the service on a periodic or continuous basis. The central hub 770 has a communications module 874 configured to communicate with the remote or cloud service. In the illustrated embodiment, the communications module 874 is configured for wireless communication via a radio and antennae. In other embodiments, the communications module 874 may be configured for wired connectivity or both wired and wireless connectivity, for example, if redundant communication modes are desired. The central hub 770 has a logic determining device and, in embodiments in which the central hub 770 is separated from all control systems 760, a power module. In embodiments in which the central hub 770 is integrated into a control system 760, the central hub 770 may share the control system's power module. The central hub 770 may be configured to transmit data and/or instructions to the control systems 760, rather than just receiving data from the control systems 760, in which case, operation of the control systems 760 and their related systems 710, 750 may be possible through the central hub 770.

The control systems and/or central hub of embodiments of the present disclosure may provide continuous monitoring of the system and sensor data logging. Continuously or at predetermined and/or adjustable intervals, the control systems/central hub transmit system status, inerting process compliance, and other sensor data to a remote monitoring service via one or more of the network connections mentioned above. The control systems and/or central hub may also be provided with process and/or operating parameters and be configured to transmit/issue a signal indicative of a process and/or operating condition falling outside of those parameters and potentially requiring operator action, system maintenance, system shutdown, or other intervention. As described herein, embodiments of the system may also provide full or partial automation of the WPNI process.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A control system for operating and/or monitoring an inerting system for a wet-pipe fire sprinkler system comprising:
a logic determining device;
a user interface in communication with the logic determining device and configured to display a status of the wet-pipe fire sprinkler system;
at least one sensor configured to monitor at least one operating parameter of the wet-pipe fire sprinkler system and wherein the at least one sensor is in communication with the logic determining device and configured to transmit a signal to the logic determining device with sensor data relating to the at least operating parameter;
a memory module in communication with the logic determining device and configured to record the sensor data;
a communications module in communication with the logic determining device and configured to transmit the sensor data to a receiving device; and
a power module configured to deliver power for the control system.

2. The control system of claim 1, further comprising a control system enclosure containing each of the logic determining device, the user interface, the memory module, and the communications module.

3. The control system of claim 1, wherein the power module comprises at least one battery.

4. The control system of claim 1, wherein the logic determining device is further configured to analyze the sensor data and determine a status of the wet-pipe fire sprinkler system for transmission by the communications module.

5. The control system of claim 4, wherein the logic determining device is further configured to generate a status report for the wet-pipe fire sprinkler system based on the analysis of the sensor data conducted by the logic determining device.

6. The control system of claim 1, wherein the receiving device is configured to analyze the sensor data and determine a status of the wet-pipe fire sprinkler system.

7. The control system of claim 1, wherein the communications module comprises at least one of a wired connection and a wireless connection with the receiving device.

8. The control system of claim 7, wherein the wired connection comprises one or a combination of serial or ethernet communication.

9. The control system of claim 7, wherein the wireless connection comprises at least one or a combination of Bluetooth, Bluetooth Low Energy, Wi-Fi, Cellular 3G/4G/5G, or Low-Power Wide Area Networking.

10. The control system of claim 1, wherein the at least one sensor comprises at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system, a flow sensor in fluid communication with the nitrogen gas source, an oxygen sensor in fluid communication with the piping network of the wet-pipe fire sprinkler system, and an oxygen sensor in fluid communication with the nitrogen gas source.

11. The control system of claim 1, wherein the system is configured to automate a wet-pipe inerting process, by executing computer-readable instructions which cause the logic determining device, in coordination with the at least one sensor to perform the steps of:
determining if the wet-pipe fire sprinkler system has been drained;
wherein if the system has not been drained a drain valve of the wet-pipe fire sprinkler system is opened;
confirming a drain valve of the wet-pipe fire sprinkler system is closed upon confirmation that the wet-pipe fire sprinkler system has been drained,
wherein if the system detects that the drain valve is open the logic determining device commands the drain valve closed;
opening a nitrogen supply valve to allow nitrogen to flow into the wet-pipe fire sprinkler system;
monitoring a pressure within the wet-pipe fire sprinkler system;
measuring an oxygen level within the wet-pipe fire sprinkler system and determining if the measured oxygen level is below a threshold oxygen level;
closing the nitrogen supply valve when the pressure within the wet-pipe fire sprinkler system reaches a threshold pressure or oxygen level;
monitoring a pressure within the wet-pipe fire sprinkler system and determining if an exhaust valve of the wet-pipe fire sprinkler system needs to be actuated to drain an amount of the gas mixture from the wet-pipe fire sprinkler system,
wherein the exhaust valve may comprise the drain valve, an air vent, or a combination thereof and if required the exhaust valve is opened only for the duration required to drain the amount of the gas mixture from the system;
repeating the above steps if the measured oxygen level is not below the threshold oxygen level; and
recording the sensor data during the inerting process and, upon completion of the inerting process, generating a report from the sensor data.

12. The control system of claim 11, wherein the control system is further configured to generate a report from the at least one sensor confirming initiation and completion of the wet-pipe inerting process and noting any deviation from the wet-pipe inerting process and transmit the report to at least one of the receiving device and the user interface.

13. The control system of claim 1, wherein the system is configured to monitor a wet-pipe inerting process, by executing computer-readable instructions which cause the logic determining device, in coordination with the at least one sensor to perform the steps of:
receiving the sensor data in the logic determining device, wherein the at least one sensor comprises at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system, a flow sensor in fluid communication with the nitrogen gas source, an oxygen sensor in fluid communication with the piping network of the wet-pipe fire sprinkler system, and an oxygen sensor in fluid communication with the nitrogen gas source;
recording the sensor data within the memory module; and
transmitting the sensor data to at least one of the receiving device and the user interface.

14. The control system of claim 13, wherein the control system is further configured to generate a report from the at least one sensor confirming initiation and completion of the wet-pipe inerting process and noting any deviation from the wet-pipe inerting process and transmit the report to at least one of the receiving device and the user interface.

15. A system for operating and/or monitoring an inerting system for a wet-pipe fire sprinkler system, comprising:
one or more control systems as set forth in claim 1; and
a central hub in communication with the one or more control systems.

16. A system for operating and/or monitoring an inerting system for a wet-pipe fire sprinkler system, comprising one or more control systems as set forth in claim 1 in common communication with a wired or wireless network.

17. A method of automating a wet-pipe inerting process for a wet-pipe fire sprinkler system, comprising the steps of:
connecting a control system with the wet-pipe fire sprinkler system, the control system comprising:
a logic determining device;
a user interface in communication with the logic determining device and configured to display a status of the wet-pipe fire sprinkler system;
at least one sensor configured to monitor at least one operating parameter of the wet-pipe fire sprinkler system and wherein the at least one sensor is in communication with the logic determining device and configured to transmit a signal to the logic determining device with sensor data relating to the at least operating parameter;
a memory module in communication with the logic determining device and configured to record the sensor data;
a communications module in communication with the logic determining device and configured to transmit the sensor data to a receiving device; and
a power module configured to deliver power for the control system;
inerting the wet-pipe fire sprinkler system, comprising the steps of:
determining if the wet-pipe fire sprinkler system has been drained,
wherein if the system has not been drained a drain valve of the wet-pipe fire sprinkler system is opened;
confirming a drain valve of the wet-pipe fire sprinkler system is closed upon confirmation that the wet-pipe fire sprinkler system has been drained;
wherein if the system detects that the drain valve is open the logic determining device commands the drain valve closed;
opening a nitrogen supply valve to allow nitrogen to flow into the wet-pipe fire sprinkler system;
monitoring a pressure within the wet-pipe fire sprinkler system;
measuring an oxygen level within the wet-pipe fire sprinkler system and determining if the measured oxygen level is below a threshold oxygen level;
closing the nitrogen supply valve when the pressure within the wet-pipe fire sprinkler system reaches a threshold pressure or oxygen level;
monitoring a pressure within the wet-pipe fire sprinkler system and determining if an exhaust valve of the wet-pipe fire sprinkler system needs to be actuated to drain an amount of the gas mixture from the wet-pipe fire sprinkler system;
wherein the exhaust valve may comprise the drain valve, an air vent, or a combination thereof and if required the exhaust valve is opened only for the duration required to drain the amount of the gas mixture from the system;
repeating the above steps if the measured oxygen level is not below the threshold oxygen level; and
recording the sensor data during the inerting process and, upon completion of the wet-pipe inerting process, transmitting the sensor data to at least one of the receiving device and the user interface.

18. The method of automating a wet-pipe inerting process for a wet-pipe fire sprinkler system of claim 17, further comprising the step of generating a report from the sensor data confirming initiation and completion of the wet-pipe inerting process and noting any deviation from the wet-pipe inerting process.

19. The method of automating a wet-pipe inerting process for a wet-pipe fire sprinkler system of claim 18, further comprising the step of transmitting the report to at least one of the receiving device and the user interface.

20. The method of automating a wet-pipe inerting process for a wet-pipe fire sprinkler system of claim 17, further comprising the steps of:
receiving the sensor data in the logic determining device, wherein the at least one sensor comprises at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system, a flow sensor in fluid communication with the nitrogen gas source, an oxygen sensor in fluid communication with the piping network of the wet-pipe fire sprinkler system, and an oxygen sensor in fluid communication with the nitrogen gas source;
recording the sensor data within the memory module; and
transmitting the sensor data to at least one of the receiving device and the user interface.

21. The method of automating a wet-pipe inerting process for a wet-pipe fire sprinkler system of claim 17, further comprising the steps of:
comparing the sensor data with at least one threshold operating parameter stored in the memory module;
identifying non-compliant sensor data falling outside of the at least one threshold operating parameter; and
generating a signal indicative of the non-compliant sensor data and transmitting the signal to at least one of a receiving device and the user interface.

22. The method of automating a wet-pipe inerting process for a wet-pipe fire sprinkler system of claim 17, further comprising the step of removing the control system from the wet-pipe fire sprinkler inerting system and transporting the control system to another wet-pipe fire sprinkler inerting system.

23. A method of monitoring a wet-pipe inerting process for a wet-pipe fire sprinkler, comprising the steps of:
connecting a control system with the wet-pipe fire sprinkler system, the control system comprising:
a logic determining device;
a user interface in communication with the logic determining device and configured to display a status of the wet-pipe fire sprinkler system;
at least one sensor configured to monitor at least one operating parameter of the wet-pipe fire sprinkler system and wherein the at least one sensor is in communication with the logic determining device and configured to transmit a signal to the logic determining device with sensor data relating to the at least operating parameter;
a memory module in communication with the logic determining device and configured to record the sensor data;
a communications module in communication with the logic determining device and configured to transmit the sensor data to a receiving device; and
a power module configured to deliver power for the control system;
receiving the sensor data in the logic determining device;
recording the sensor data within the memory module; and
transmitting the sensor data to at least one of the receiving device and the user interface.

24. The method of monitoring a wet-pipe inerting process for a wet-pipe fire sprinkler system of claim 23, wherein the at least one sensor comprises at least one of a pressure sensor in fluid communication with a nitrogen gas source, a pressure sensor in fluid communication with a piping network of the wet-pipe fire sprinkler system, a liquid sensor in fluid communication with a piping network of the wet-pipe fire sprinkler system, a flow sensor in fluid communication with a piping network of the wet-pipe fire sprinkler system, a flow sensor in fluid communication with the nitrogen gas source, an oxygen sensor in fluid communication with the piping network of the wet-pipe fire sprinkler system, and an oxygen sensor in fluid communication with the nitrogen gas source.

25. The method of monitoring a wet-pipe inerting process for a wet-pipe fire sprinkler system of claim 23, further comprising the step of generating a report from the sensor data confirming initiation and completion of the wet-pipe inerting process and noting any deviation from the wet-pipe inerting process.

26. The method of monitoring a wet-pipe inerting process for a wet-pipe fire sprinkler system of claim 25, further comprising the step of transmitting the report to at least one of the receiving device and the user interface.

27. The method of monitoring a wet-pipe inerting process for a wet-pipe fire sprinkler system of claim 23, further comprising the steps of:
comparing the sensor data with at least one threshold operating parameter stored in the memory module;
identifying non-compliant sensor data falling outside of the at least one threshold operating parameter; and
generating a signal indicative of the non-compliant sensor data and transmitting the signal to at least one of a receiving device and the user interface.

28. The method of monitoring a wet-pipe inerting process for a wet-pipe fire sprinkler system of claim 23, further comprising the step of removing the control system from the wet-pipe fire sprinkler system and transporting the control system to another wet-pipe fire sprinkler system.
